(19) United States
(12) Patent Application Publication
(10) Pub. No.: US 2015/0014899 A1
(43) Pub. Date: Jan. 15, 2015

(54) METHOD FOR MANUFACTURING LAMINATED COIL COMPONENT

(71) Applicant: MURATA MANUFACTURING CO., LTD., Kyoto-fu (JP)

(72) Inventors: Kunihiko HAMADA, Kyoto-fu (JP); Eiichi MAEDA, Kyoto-fu (JP); Kenji KAWABATA, Kyoto-fu (JP)

(73) Assignee: MURATA MANUFACTURING CO., LTD., Kyoto-fu (JP)

(21) Appl. No.: 14/503,787

(22) Filed: Oct. 1, 2014

Related U.S. Application Data
(63) Continuation of application No. PCT/JP2013/068536, filed on Jul. 5, 2013.

(30) Foreign Application Priority Data
Jul. 20, 2012 (JP) 2012-161415

(51) Int. Cl. H01F 41/04

(52) U.S. Cl. CPC H01F 41/04; H01F 41/043; H01F 41/045
USPC 264/611

(57) ABSTRACT

A method includes: a laminate block preparing step of preparing a laminate block as an assembly of a number of laminates, by alternately laminating magnetic layers containing, as their main constituent, a magnetic metal material containing a glass material and conductor layers containing a conductive material so that the conductor layers are electrically connected to each other to form a coil pattern; a dividing step of dividing the laminate block by cutting the laminate block for each of the laminates; a magnetic material applying step of applying a magnetic material containing the magnetic metal material to side surfaces of the laminates; and a firing step of firing the laminates with the magnetic material applied thereto, thereby preparing a component body. This achieves a method for manufacturing a laminated coil component preferred for a power inductor with improved reliability, without impairing direct-current superimposition characteristics.

### CROSS REFERENCE TO RELATED APPLICATIONS

This application claims benefit of priority to Japanese Patent Application No. 2012-161415 filed Jul. 20, 2012, and to International Patent Application No. PCT/JP2013/068536 filed on Jul. 5, 2013, the entire content of each of which is incorporated herein by reference.

### TECHNICAL FIELD

The present technical field relates to a method for manufacturing a laminated coil component, more particularly, to a method for manufacturing a laminated coil component such as a power inductor including a magnetic layer containing a magnetic metal material as its main constituent.

### BACKGROUND

Conventionally, laminated coil components which have a component body formed with the use of a metallic magnetic material of a magnetic metal material with a surface coated with a glass material, and have a coil conductor embedded in the component body are known as electronic components, such as power inductors for use in DC/DC converters and power circuits through which large current flows.

For example, Japanese Patent Application Laid-Open No. 2010-62424 proposes a method for manufacturing an electronic component, where glass that contains SiO₂, B₂O₃, and ZnO as its main constituents, and that has a softening temperature of 600±50° C. is added to a metallic magnetic alloy powder containing Cr, Si, and Fe so that the glass is less than 10% of the metallic magnetic alloy powder in volume. A metallic magnetic material of the metallic magnetic alloy powder with the surface coated with the glass is used to form a compact with a coil embedded therein. The compact is subjected to firing at a temperature of 700° C. or higher and less than the melting point of the coil conductor material in vacuum, or in a non-oxidizing atmosphere without oxygen or with a low oxygen partial pressure.

Japanese Patent Application Laid-Open No. 2010-62424 makes it possible to increase the insulation resistance without increasing the resistance of the coil by using the manufacturing method, thereby providing a power inductor with favorable direct-current superimposition characteristics and a reduced magnetic loss.

On the other hand, various types of laminated coil components with ferrite magnetic materials have been conventionally proposed.

For example, Japanese Patent Application Laid-Open No. 2001-44039 proposes a chip ferrite component including: a component body (magnetic ferrite main body) configured with a magnetic ferrite material, and an internal conductor buried in the component body so as to constitute a coil, where the internal conductor is provided so as to be at least partially exposed to the outside, and the part exposed to the outside is coated with a non-magnetic material.

This Japanese Patent Application Laid-Open No. 2001-44039 provides an open magnetic circuit structure configured as described above, thus making it possible to achieve a chip ferrite component that is stable in inductance or impedance under large current conditions.

### SUMMARY

### Problems to be Solved by the Disclosure

According to Japanese Patent Application Laid-Open No. 2010-62424, because the component body is formed from the metallic magnetic material, the saturated magnetic flux density Bs is higher and less likely to reach the magnetic saturation as compared with the chip ferrite component formed from the ferrite magnetic material as the component body as in Japanese Patent Application Laid-Open No. 2001-44039, and a laminated coil component is thus believed to be obtained which has favorable direct-current superimposition characteristics with a low rate of inductance change even when a large electric current is allowed to flow.

On the other hand, this type of laminated coil component is commonly manufactured in a manner that provides a number of components, from the perspective of ensuring favorable productivity.

The manner that provides a number of components refers to a manner that provides a number of laminates from a single laminate block by preparing an assembly of laminates to serve as component bodies after being subjected to firing with the use of a lamination method or the like, and horizontally and vertically cutting the laminate block as the assembly of laminates. Then, these laminates are subjected to firing to obtain a number of component bodies from the single laminate block, and the formation of external electrodes on the component bodies makes it possible to manufacture laminated coil components with high efficiency.

However, Japanese Patent Application Laid-Open No. 2010-62424 has the following problem when the manner that provides a number of components as described above is used to manufacture laminated coil components.

More specifically, according to Japanese Patent Application Laid-Open No. 2010-62424, the metallic magnetic body with the coil embedded therein is formed from the metallic magnetic material with the surface coated with the glass material, and thus, in cutting the laminate block, there is a possibility that the metallic magnetic body will be damaged to lose the glass material coating the metallic magnetic material, and expose the metallic magnetic material at the surface. Then, because this metallic magnetic material is inferior in corrosion resistance, there is a possibility that the exposed section will be corroded to form rust and cause characteristic degradation, when the metallic magnetic material is surface-exposed.

On the other hand, when the component body is formed from the ferrite magnetic material as in Japanese Patent Application Laid-Open No. 2001-44039, the saturated magnetic flux density Bs is lower and more likely to reach magnetic saturation as compared with the metallic magnetic material, although the high resistivity leads to a small eddy current loss even in a high-frequency region.

Therefore, according to Japanese Patent Application Laid-Open No. 2001-44039, the component body is partially exposed to the outside, and the section exposed to the outside is coated with a non-magnetic material to provide an open magnetic circuit structure, thus in an attempt to improve direct-current superimposition characteristics.

However, the ferrite magnetic material for use in Japanese Patent Application Laid-Open No. 2001-44039 fails to achieve such favorable direct-current superimposition characteristics as in the case of the metallic magnetic material because of the material property, and for this reason, it is difficult to achieve desired direct-current superimposition characteristics required for power inductors.

The present disclosure has been achieved in view of these circumstances, and an object of the present disclosure is to provide a method for manufacturing a laminated coil component preferred for a power inductor with improved reliability, without impairing direct-current superimposition characteristics.

### Means for Solving the Problems

In order to achieve the object mentioned above, a method for manufacturing a laminated coil component according to the present disclosure is characterized in that the method includes: a laminate block preparing step of preparing a laminate block as an assembly of a number of laminates, by alternately laminating magnetic layers containing, as their main constituent, a magnetic metal material containing at least a glass material and conductor layers containing a conductive material so that the conductor layers are electrically connected to each other to form a coil pattern; a dividing step of dividing the laminate block by cutting the laminate block for each of the laminates; a magnetic material applying step of applying a magnetic material containing the magnetic metal material to a side surface of each of the laminates; and a firing step of firing the laminates with the magnetic material applied thereto to prepare component bodies.

Thus, even when the glass material contained in the conductor layers is damaged and lost in the division of the laminate block in the dividing step, the fired component bodies never cause the conductor sections to be surface-exposed, because the magnetic material is applied to the side surfaces of the laminates. Furthermore, due to the fact that the conductor sections are not surface-exposed as just described, it becomes possible to achieve a laminated coil component which causes no characteristic degradation, without bringing the conductor sections into contact with the atmosphere to form rust.

In addition, in the method for manufacturing a laminated coil component according to the present disclosure, in the dividing step, the laminate block is preferably divided so that the conductor layers are at least partially surface-exposed from the side surfaces of the laminates.

Thus, even when the conductor layers are at least partially surface-exposed from the side surfaces of the laminates, it becomes possible to achieve, without forming any rust, a laminated coil component preferred for a power inductor further reduced in size, because the magnetic material is applied to the side surfaces.

In addition, in the method for manufacturing a laminated coil component according to the present disclosure, preferably, the laminate block preparing step includes: a magnetic paste preparing step of preparing a magnetic paste containing, as its main constituent, the magnetic metal material containing at least the glass material; a magnetic layer preparing step of preparing sheet-like magnetic layers by applying a forming process to the magnetic paste; a conductor layer forming step of forming conductor layers each having a predetermined conductor pattern by applying a conductive paste containing the conductive material to the magnetic layers; and a laminating step of laminating the magnetic layers with the conductor layers formed so that the conductor layers are electrically connected to each other to form a coil pattern, and in the magnetic material applying step, the magnetic paste is applied to the side surface of each of the laminates.

Furthermore, in the method for manufacturing a laminated coil component according to the present disclosure, the magnetic paste preparing step preferably includes: a magnetic raw material preparing step of preparing a magnetic raw material by coating the surface of the magnetic metal material with the glass material; and a paste making step of making the magnetic raw material into a paste.

Thus, even when the glass material coating the surface of the magnetic metal material is damaged and lost in the cutting in the dividing step, rust formation can be avoided at the internal conductors, with the magnetic metal material coated with the magnetic material. Advantageous effect of the disclosure

The method for manufacturing a laminated coil component according to the present disclosure includes: a laminate block preparing step of preparing a laminate block as an assembly of a number of laminates, by alternately laminating magnetic layers containing, as their main constituent, a magnetic metal material containing at least a glass material and conductor layers containing a conductive material so that the conductor layers are electrically connected to each other to form a coil pattern; a dividing step of dividing the laminate block by cutting the laminate block for each of the laminates; a magnetic material applying step of applying a magnetic material containing the magnetic metal material to side surfaces of the laminates; and a firing step of firing the laminates with the magnetic material applied thereto to prepare component bodies. Thus, even when the glass material contained in the conductor layers is damaged and lost in the division of the laminate block in the dividing step, the fired component bodies never cause the magnetic metal material which is inferior in corrosion resistance to be surface-exposed, because the magnetic material is applied to the side surfaces of the laminates. Furthermore, due to the fact that the conductor sections are not surface-exposed as just described, it becomes possible to achieve a laminated coil component which causes no characteristic degradation, without bringing the conductor sections into contact with the atmosphere to form rust.

Moreover, due to the fact that the component bodies contain the magnetic metal material as their main constituent, more favorable direct-current superimposition characteristics are produced as compared with a case of forming the component bodies from a ferrite material, and thus, it becomes possible to achieve a laminated coil component preferred for a power inductor, etc. with favorable direct-current superimposition characteristics and favorable reliability.

### BRIEF DESCRIPTION OF THE DRAWINGS

FIG. 1 is a perspective view illustrating an embodiment of a laminated coil component manufactured by a manufacturing method according to the present disclosure.

FIG. 2 is a schematic cross-sectional view of FIG. 1.

FIG. 3 is a perspective view illustrating an embodiment of a laminate block.

FIG. 4 is an exploded perspective view of a laminate.

FIG. 5 is a perspective view of a laminate.

FIG. 6 is a perspective view of a laminate with magnetic material-applied sections formed.

### DETAILED DESCRIPTION

Next, an embodiment of the present disclosure will be described in detail.

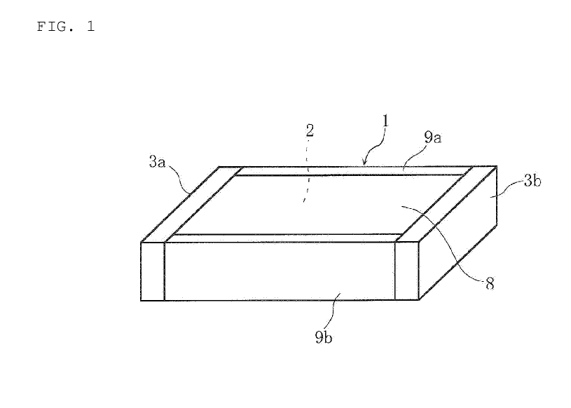

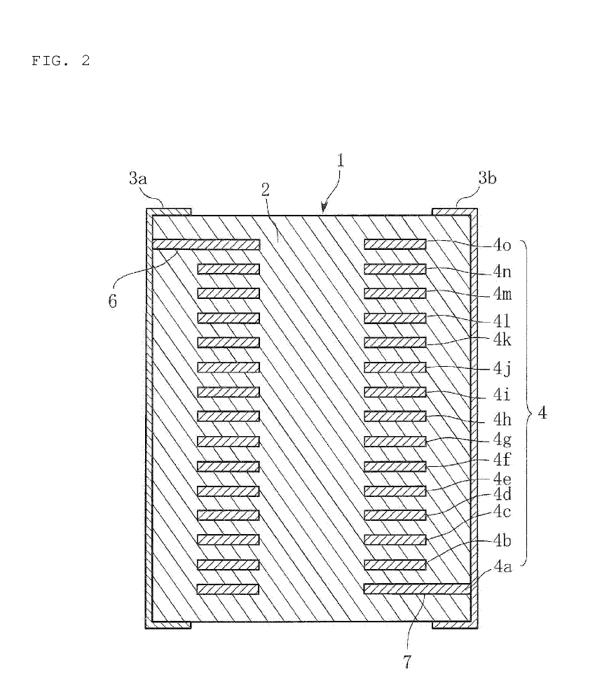

FIG. 1 is a perspective view illustrating an embodiment of a laminated coil component according to the present disclosure, and FIG. 2 is a schematic cross-sectional view of FIG. 1.

This laminated coil component is composed of: a component body 1; a coil conductor 2 embedded in the component body 1; external conductors 3a, 3b formed on both ends of the component body 1.

In addition, the coil conductor 2 has, as shown in FIG. 2, internal conductors 4 (4a to 4o) each formed so as to provide a predetermined conductor pattern, which are electrically connected in series through via conductors (not shown), and wound in a coiled form. Furthermore, in this laminated coil component, a leading portion 6 of the internal conductor 4o is electrically connected to the external electrode 3a, and a leading portion 7 of the internal conductor 4a is electrically connected to the other external electrode 3b.

In addition, the component body 1 is, as shown in FIG. 1, composed of: a magnetic main body 8 containing a magnetic metal material as its main constituent and a glass material as an accessory constituent; and magnetic material-applied sections 9a, 9b of magnetic material formed on side surfaces of the magnetic main body 8.

Next, a method for manufacturing the laminated coil component described above will be described in detail.

First, a magnetic metal material and a glass material are prepared.

The magnetic metal material is not to be considered particularly limited as long as the material is a metal material with magnetism, but various types of crystalline or amorphous magnetic metal materials containing Fe as its main constituent can be used, such as, for example, a Fe—Si system containing Si, a Fe—Si—Cr system containing Si and Cr, a Fe—Ni system containing Ni, and a Fe—Si—Al system containing Si and Al.

In addition, the glass material is also not to be considered particularly limited, but various types of glass materials can be used such as a Si—B system, a Si—B-alkali metal system, a Si—B—Zn system, and liquid glass.

Then, the magnetic metal material and glass material are mixed to coat the surface of the magnetic metal material with the glass material, thereby preparing a magnetic raw material.

The method for coating the surface of the magnetic metal material with the glass material is also not to be considered particularly limited, but for example, a mechanofusion method or the like can be used to coat the surface of the magnetic metal material with the glass material. More specifically, the surface of the magnetic metal material can be coated with the glass material by mixing the magnetic metal material and the glass material, and applying mechanical energy to the mixture to develop a mechanochemical reaction.

It is to be noted that the combination ratio between the magnetic metal material and the glass material may be any ratio as long as the magnetic metal material forms a main constituent, but for example, the materials are combined so that the content of the magnetic metal material is 70 to 90 weight %.

Then, this magnetic raw material is subjected to kneading with the addition of additives such as an organic solvent, an organic binder, a dispersant, and a plasticizer to the material, thereby preparing a magnetic paste.

Further, a conductive powder such as an Ag powder is subjected to kneading with the addition of varnish and an organic solvent to the powder, thereby preparing a conductive paste for internal conductors (hereinafter, referred to as an “internal conductor paste”).

Next, the magnetic paste and internal conductor paste are used to prepare a laminate block.

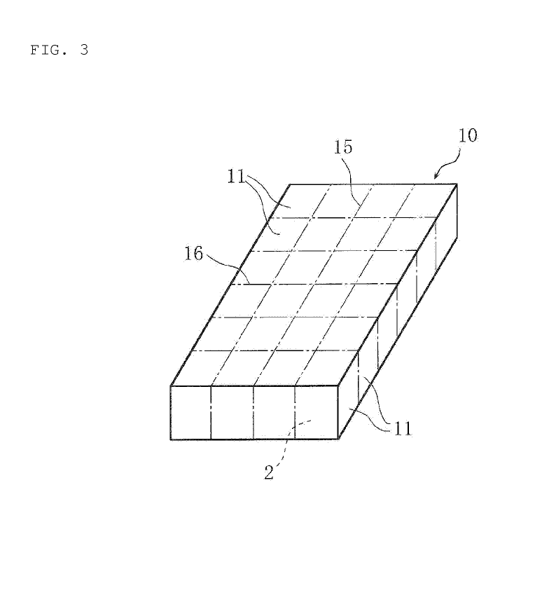

FIG. 3 is a perspective view of the laminate block.

This laminate block 10 is an assembly of laminates 11, and prepared on a base film (not shown) such as polyethylene terephthalate (PET) with the use of a lamination method. Furthermore, this laminate block 10 is provided with cutting-plane lines 15, 16 so that a single laminate 11 forms a single component body 1 after firing. Then, the laminate block 10 is cut along the cutting-plane lines 15, 16 with the use of a cutting tool such as a dicer or a cutting blade, thereby forming the laminates 11 to serve as component bodies 1 after being subjected to firing.

Next, a method for preparing the laminate 11 will be described.

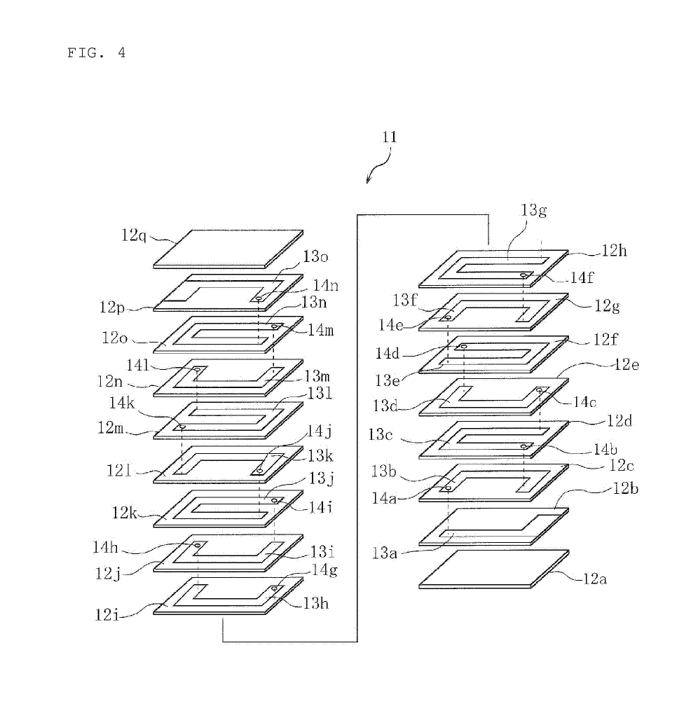

FIG. 4 is an exploded perspective view of the laminate 11.

First, the magnetic paste is applied onto the base film, and dried to prepare magnetic sheets 12a, 12b. Then, the internal conductor paste is applied by a screen printing method or the like onto the surface of the magnetic sheet 12b, and dried to form a conductor layer 13a in a predetermined pattern.

Then, the magnetic paste is applied onto the magnetic sheet 12b with the conductor layer 13a formed thereon, and dried to prepare a magnetic sheet 12c. Then, the internal conductor paste is applied by a screen printing method or the like onto the surface of the magnetic sheet 12c, and dried to form a conductor layer 13b in a predetermined pattern. It is to be noted that in the formation of the magnetic sheet 12c, a via hole 14a is formed so that the conductor layer 13b and the conductor layer 13a are able to provide conduction.

Hereinafter, the magnetic paste and the internal conductor paste are used in the same way and in accordance with the same procedure to sequentially form magnetic sheets 12d to 12q and conductor layers 13c to 13o, and via holes 14b to 14n are formed in the same manner in the formation of the magnetic sheets 12d to 12q so that the upper and lower conductor layers provide conduction. Thus, on the base film, a number of laminates 11 are prepared in a matrix form in an integrated manner to form the laminate block 10.

Then, as described above, a cutting tool is used to cut the laminate block 10 along the cutting-plane lines 15, 16, thereby forming laminates 11 as shown in FIG. 5.

Then, after the magnetic paste is applied to side surfaces of the laminate 11 to provide the magnetic material, the laminate 11 with the magnetic material provided is put in a sagger, subjected to a binder removal treatment at a temperature of 300 to 500° C. under a nitrogen atmosphere, and thereafter, subjected to a firing treatment at a temperature of 900 to 1000° C. under a nitrogen atmosphere, thereby providing the component body 1.

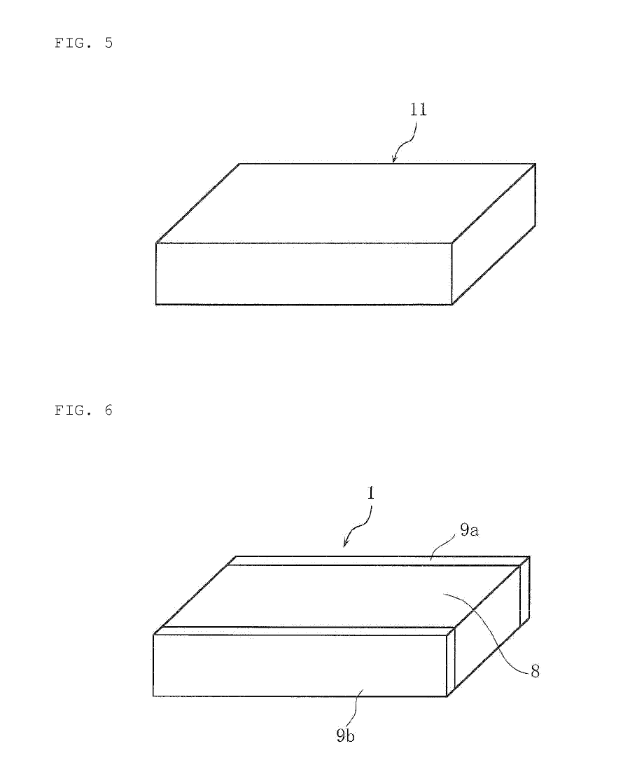

FIG. 6 is a perspective view of the component body 1, with the magnetic material-applied sections 9a, 9b formed on side surfaces of the magnetic main body 8.

Thereafter, a paste for external electrodes, which contains Ag or the like as its main constituent, is applied to both ends of the component body 1, and subjected to a baking treatment to form the external electrodes 3a, 3b, thereby forming the laminate coil component.

As just described, the present embodiment includes: a laminate block preparing step of alternately laminating the magnetic sheets 12a to 12q (magnetic layers) that contain, as their main constituent, a magnetic metal material containing at least a glass material and the conductor layers 13a to 13o to prepare the laminate block 10 as an assembly of a number of laminates 11; a dividing step of dividing the laminate block by cutting the laminate block for each laminate 11; a magnetic material applying step of applying a magnetic material including the magnetic metal material to side surfaces of the laminates 11; and a firing step of firing the laminates 11 with the magnetic material applied thereto to prepare the component body 1 so that the conductor layers 13a to 13o containing a conductive material are electrically connected to each other to form a coil pattern. Thus, even when the glass material contained in the conductor layers 13a to 13o is damaged and lost in dividing the laminate block 10 in the dividing step, the magnetic metal material of the fired component body 1, which is inferior in corrosion resistance, will not be surface-exposed, because the magnetic material is applied to the side surfaces of the laminate 11. More specifically, even when the glass material coating the surface of the magnetic metal material is damaged and lost in the cutting in the dividing step, rust formation can be avoided at the coil conductor 2, because the magnetic metal material is coated with the magnetic material.

Furthermore, due to the fact that the magnetic metal material is not surface-exposed as just described, it becomes possible to achieve a laminated coil component which causes no characteristic degradation, without bringing the conductor sections into contact with the atmosphere to form rust.

Moreover, due to the fact that the component body 1 contains the magnetic metal material as their main constituent, more favorable direct-current superimposition characteristics are produced as compared with a case of forming a component body 1 from a ferrite material, and thus, it becomes possible to achieve a laminated coil component preferred for a power inductor, etc. with favorable direct-current superimposition characteristics and favorable reliability.

It is to be noted that the present disclosure is not to be considered limited to the embodiment described above, but various modifications can be made without departing from the spirit and scope of the disclosure.

While the laminate block 10 is provided with the cutting-plane lines 15, 16 to cut the laminate block 10 along the cutting-plane lines 15, 16 in the dividing step so that a single laminate 11 forms a single component body 1 after being subjected to firing, it is also preferable to divide the laminate block 10 so that the conductor layers 13a to 13o are at least partially surface-exposed from side surfaces of the laminates 11. In this case, while the conductor layers 13a to 13o are at least partially surface-exposed from the side surfaces of the laminate 11, it becomes possible to achieve, without forming any rust, a laminated coil component preferred for a power inductor further reduced in size, because the magnetic material is applied to the side surfaces.

Next, an example of the present disclosure will be specifically described. Example

A Fe—Si—Cr magnetic metal powder of 6 μm in average particle size, with Fe: 92.0 weight %, Si: 3.5 weight %, and Cr: 4.5 weight %, was prepared as the magnetic metal material.

Further, a glass powder of borosilicate alkali glass of 1 μm in average particle size, with SiO₂: 79 weight %, B₂O₂: 19 weight %, and K₂O: 2 weight %, and a softening point of 760° C., was prepared as the glass material.

Then, the magnetic metal material and the glass material were mixed containing magnetic metal powder: 88 weight % and glass powder: 12 weight %, and a mechanofusion method was used to coat the surface of the magnetic metal material with the glass material, thereby preparing a magnetic raw material.

Next, 26 parts by weight of dihydroterpinylacetate as an organic solvent, 3 parts by weight of ethyl cellulose as an organic binder, 1 part by weight of a dispersant, and 1 part by weight of a plasticizer were weighed with respect to 100 parts by weight of the magnetic raw material, and subjected to kneading to prepare a magnetic paste.

Furthermore, an internal conductor paste containing an Ag powder, varnish, and an organic solvent was prepared.

Then, the magnetic paste was applied onto a PET film and dried repeatedly predetermined times to prepare a magnetic sheet, and the internal conductor paste was then applied to the surfaces of the magnetic sheet with the use of a screen printing method, and dried to form a conductor layer in a predetermined pattern.

Then, the magnetic paste was applied onto the magnetic sheet with the conductor layer formed thereon, and dried to prepare a magnetic sheet. In this case, a via hole was formed in a predetermined position of the magnetic sheet.

Then, the internal conductor paste was applied to the surface of the magnetic sheet with the use of a screen printing method, and dried to form a conductor layer in a predetermined pattern. In this case, the conductor layer was adapted to provide conduction to the initially formed conductor layer through the via hole.

Thereafter, the magnetic paste and the internal conductor paste were used in the same way and in accordance with the same procedure to sequentially form magnetic sheets and conductor layers, thereby forming an assembly of laminates with a conductor pattern as shown in FIG. 4, that is, a laminate block.

Then, a dicer was used to cut the laminate block, thereby providing laminates.

Then, the magnetic paste was applied to side surfaces of the laminates, and dried to obtain laminates with the magnetic material applied thereto.

Then, the laminate was put in a sagger, heated for 2 hours at a temperature of 400° C. in a nitrogen atmosphere to achieve a binder removal treatment, and then subjected to a firing treatment for 90 minutes at a temperature of 900° C. in a nitrogen atmosphere to obtain a component body.

Then, a paste for external electrodes, containing Ag or the like as its main constituent, was applied to both ends of the component body with the use of an immersion method, dried for 10 minutes at a temperature of 100° C. in a nitrogen atmosphere, and then subjected to a baking treatment for 15 minutes at a temperature of 780° C. to form external electrodes, thereby preparing a laminated coil component (sample of Example).

In addition, as a Comparative Example, a laminate block was prepared in the same way and in accordance with the same procedure as described above, the laminate block was cut for dividing for each laminate thereafter, and the laminate was subjected to firing without applying the magnetic paste to side surfaces of the laminate, thereby preparing a laminated coil component with the laminate as a component body (sample of Comparative Example).

Next, 100 pieces for each of the thus prepared samples of Example and Comparative Example were left for 500 hours in a thermostatic bath kept at a relative humidity of 95% RH and a temperature of 40° C., and observed with an optical microscope on whether or not each sample underwent a color change due to rust or the like.

As a result, it has been confirmed that 60 samples out of the 100 pieces underwent an appearance change in color in the case of the sample of Comparative Example, whereas the samples underwent no color change at all in the case of the sample of Example.

### INDUSTRIAL APPLICABILITY

Even in the case of manufacturing the laminated coil component including the component body containing the magnetic metal material as its main constituent in a manner that provides a number of components, rust formation can be avoided at the outer surface, and laminated coil components can be achieved which have favorable direct-current superimposition characteristics and excellent reliability.

1. A method for manufacturing a laminated coil component, the method comprising:
preparing a laminate block as an assembly of a number of laminates, by alternately laminating magnetic layers containing, as a main constituent, a magnetic metal material containing at least a glass material and conductor layers containing a conductive material so that the conductor layers are electrically connected to each other to form a coil pattern;
dividing the laminate block by cutting the laminate block for each of the laminates;
applying a magnetic material containing the magnetic metal material to a side surface of each of the laminates; and
firing the laminates with the magnetic material applied thereto to prepare component bodies.

2. The method for manufacturing a laminated coil component according to claim 1, wherein in the dividing step, the laminate block is divided so that the conductor layers are at least partially surface-exposed from the side surfaces of the laminates.

3. The method for manufacturing a laminated coil component according to claim 1, wherein the laminate block preparing step comprises:
preparing a magnetic paste containing, as a main constituent, the magnetic metal material containing at least the glass material;
preparing sheet-like magnetic layers by applying a forming process to the magnetic paste;
forming conductor layers each having a predetermined conductor pattern by applying a conductive paste containing the conductive material to the magnetic layers; and
laminating the magnetic layers with the conductor layers formed so that the conductor layers are electrically connected to each other to form a coil pattern, and in the magnetic material applying step, the magnetic paste is applied to the side surface of each of the laminates.

4. The method for manufacturing a laminated coil component according to claim 3, wherein the magnetic paste preparing step comprises:
preparing a magnetic raw material by coating a surface of the magnetic metal material with the glass material; and
making the magnetic raw material into a paste.
